(19) United States
(12) Patent Application Publication
(10) Pub. No.: US 2018/0246370 A1
(43) Pub. Date: Aug. 30, 2018

(54) METHOD FOR MANUFACTURING LIQUID CRYSTAL DISPLAY PANEL

(71) Applicants: HKC Corporation Limited, Shenzhen City, Guangdong (CN); Chongqing HKC Optoelectronics Technology Co., Ltd., Chongqing (CN)

(72) Inventor: Yu-Jen CHEN, Chongqing (CN)

(21) Appl. No.: 15/561,829

(22) PCT Filed: Aug. 17, 2017
(86) PCT No.: PCT/CN2017/097877

§ 371 Date: Sep. 26, 2017

(30) Foreign Application Priority Data
Dec. 30, 2016 (CN) 201611262946.0

(51) Int. Cl. G02F 1/1335; G02F 1/1333

(52) U.S. Cl. CPC G02F 1/133514; G02F 1/133308; G02F 1/133512

(57) ABSTRACT

This application relates to a method for manufacturing a liquid crystal display panel, including: providing a first substrate; providing a second substrate including a display region and a bezel region, where the bezel region is located on an edge of the second substrate and surrounds the display region; forming a color filter layer on the display region of the second substrate, where the color filter layer has a first thickness; forming a flat layer on the bezel region of the second substrate, where the flat layer surrounds the color filter layer, the flat layer has a second thickness, and the second thickness is the same as the first thickness, so that the flat layer is flush with the color filter layer, and the flat layer is connected to the color filter layer to form a same plane.

### BACKGROUND

### Technical Field

This application relates to a method for manufacturing a liquid crystal display panel, and in particular, to a method for manufacturing a color filter on TFT (COT)-type liquid crystal display panel.

### Related Art

Recently, a COT-type liquid crystal display using a thin film transistor (TFT) a color filter formed on a first substrate and a color filter is used due to the advantage that in the COT-type liquid crystal display, alignment margins of the first substrate and a second substrate are minimized to increase the aperture ratio.

In a screen process of current COT technologies, a mismatch between a display region and an edge region thereof may be easily caused due to a topographical difference, leading to poor liquid crystal dispersion. Consequently, the problem of vacuum bubbles occurs on the edge during a cell formation process. Therefore, to overcome vacuum bubbles on the edge is a subject on which great efforts are always made in the COT process.

### SUMMARY

To resolve the foregoing technical problem, this application provides a method for manufacturing a liquid crystal display panel, comprising:

providing a first substrate;

providing a second substrate comprising a display region and a bezel region, where the bezel region is located on an edge of the second substrate and surrounds the display region;

forming a color filter layer on the display region of the second substrate, where the color filter layer has a first thickness;

forming a flat layer on the bezel region of the second substrate, where the flat layer surrounds the color filter layer, and at least some materials of the flat layer are the same as at least some materials of the color filter layer; and

forming a liquid crystal layer between the first substrate and the second substrate, where

the flat layer has a second thickness, and the second thickness is the same as the first thickness, so that the flat layer is flush with the color filter layer, and the flat layer is connected to the color filter layer to form a same plane.

In some embodiments, the flat layer comprises a red color filter layer, a green color filter layer, and a blue color filter layer.

In some embodiments, the flat layer is a red color filter layer, a green color filter layer, or a blue color filter layer.

In some embodiments, the flat layer is a white color filter layer.

In some embodiments, the flat layer is a polymer material layer.

In some embodiments, a support column is disposed on the first substrate.

In some embodiments, a black matrix is further comprised between the first substrate and the support column.

In some embodiments, when the flat layer is formed, a secondary support column is formed on the flat layer.

In some embodiments, a length of the secondary support column is less than a length of the support column.

In some embodiments, the secondary support column is integrally formed on the flat layer.

In some embodiments, the secondary support column and the flat layer are simultaneously formed in a same photomask manufacturing process.

This application further provides a method for manufacturing a liquid crystal display panel, comprising:

providing a first substrate, where a support column is disposed on the first substrate;

providing a second substrate comprising a display region and a bezel region, where the bezel region is located on an edge of the second substrate and surrounds the display region;

forming a color filter layer on the display region of the second substrate, where the color filter layer has a first thickness;

forming a flat layer on the bezel region of the second substrate, where the flat layer surrounds the color filter layer, and at least some materials of the flat layer are the same as at least some materials of the color filter layer; and

forming a liquid crystal layer between the first substrate and the second substrate, where

the flat layer has a second thickness, and the second thickness is the same as the first thickness, so that the flat layer is flush with the color filter layer, and the flat layer is connected to the color filter layer to form a same plane; and

when the flat layer is formed, a secondary support column is formed on the flat layer, and a length of the secondary support column is less than a length of the support column.

The beneficial effects of this application are as follows: Because of a manufacturing process of the color filter layer, the flat layer is flush with the color filter layer, and the flat layer is connected to the color filter layer to form a same plane. Therefore, this can resolve the problem of vacuum bubbles on an edge caused because a large mismatch between the display region and the edge region leads to poor liquid crystal dispersion during cell formation, and reduce a use area of a circuit region on the bezel region, so that the substrates become smaller.

Further, the beneficial effects of this application are as follows: The color filter layer and the flat layer use a same material. Therefore, costs can be effectively reduced, and a success rate after cell formation can be improved.

### BRIEF DESCRIPTION OF THE DRAWINGS

FIG. 1a is a schematic diagram of a screen process of a COT technology according to a known process of this application;

FIG. 1b is a schematic diagram of an area in which vacuum bubbles are generated in the screen process of the COT technology according to the known process of this application;

FIG. 2a is a schematic diagram of a flat layer of a liquid crystal display panel according to an embodiment of this application;

FIG. 2b is a schematic diagram of an edge region and a display region of a liquid crystal display panel according to an embodiment of this application;

FIG. 2c is a schematic diagram of a gate circuit of a liquid crystal display panel according to an embodiment of this application;

FIG. 2d is a schematic diagram of a flat layer, covering a gate circuit, of a liquid crystal display panel according to an embodiment of this application;

FIG. 3a is a schematic diagram of a flat layer, including color filter layers of three colors, of a liquid crystal display panel according to an embodiment of this application;

FIG. 3b is a schematic diagram of a flat layer, being a single color filter layer, of a liquid crystal display panel according to an embodiment of this application;

FIG. 3c is a schematic diagram of a flat layer, being a white color filter layer, of a liquid crystal display panel according to an embodiment of this application; and

FIG. 4 is a schematic diagram of a flat layer and a color filter layer of a liquid crystal display panel according to an embodiment of this application.

### DETAILED DESCRIPTION

The following embodiments are described with reference to the accompanying drawings, used to exemplify specific embodiments for implementation of this application. Terms about directions mentioned in this application, such as “above”, “below”, “front”, “back”, “left”, “right”, “inside”, “outside”, and “side surface” merely refer to directions with reference to the accompanying drawings. Therefore, the used terms about directions are used to describe and understand this application, and are not intended to limit this application.

The accompanying drawings and the description are considered to be essentially exemplary, rather than limitative. In the figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, a region, and the like are enlarged. In the accompanying drawings, for understanding and ease of description, thicknesses of some layers and regions are enlarged. It should be understood that when a component such as a layer, a film, a region, or a base is described to be “on” “another component”, the component may be directly on the another component, or there may be an intermediate component.

In addition, in this specification, unless otherwise explicitly described, the word “include” is understood as including the component, but not excluding any other component. In addition, in this specification, “on” means that one is located above or below a target component and does not necessarily mean that one is located on the top based on a gravity direction.

To further describe the technical means used in this application to achieve the application objective and effects thereof, specific implementations, structures, features, and effects of a COT-type liquid crystal display and a bezel design thereof provided according to this application are described in detail below with reference to the accompanying drawings and preferred embodiments.

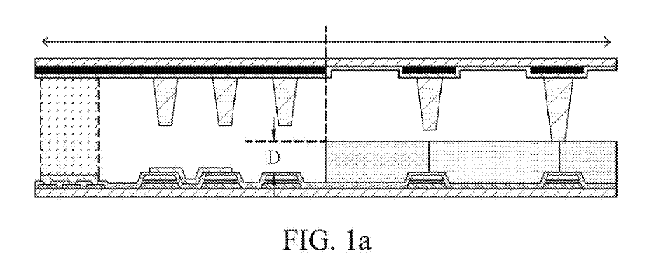

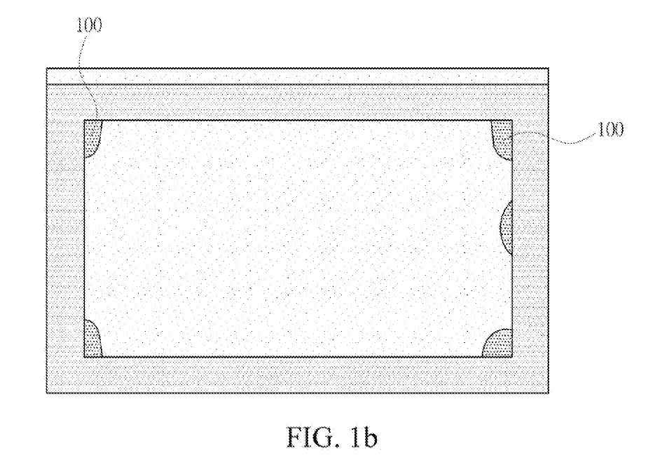

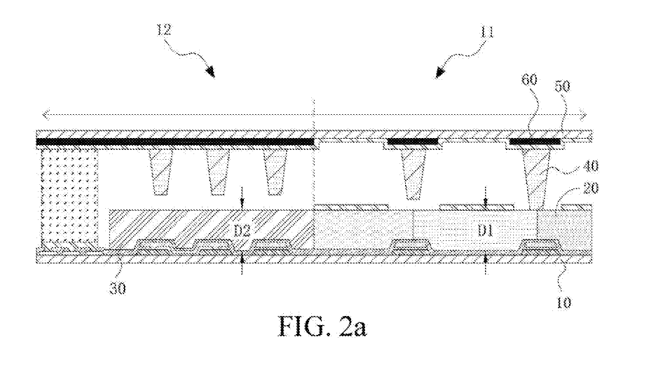

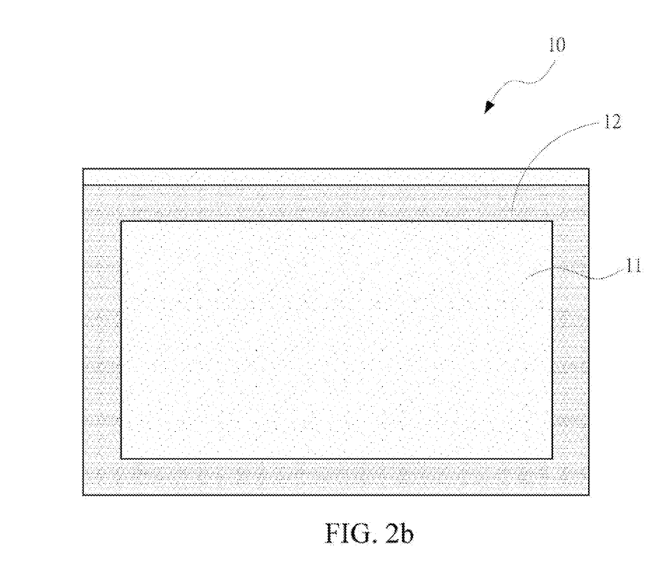

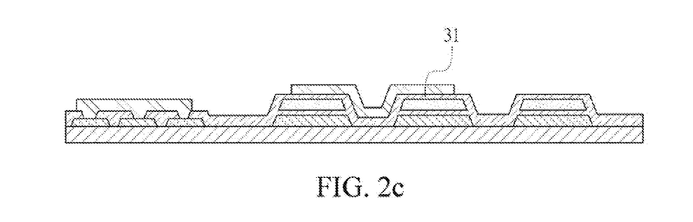

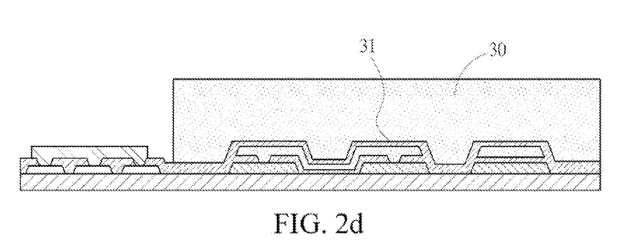

Referring to FIG. 1a and FIG. 1b, FIG. 1a is a schematic diagram of a screen process of an exemplary COT technology of this application, and FIG. 1b is a schematic diagram of an area in which vacuum bubbles are generated in the screen process of the exemplary COT technology of this application. As regards the screen process of the COT technology, a mismatch D between a display region and an edge region thereof is easily caused due to a topographical difference, leading to poor liquid crystal dispersion. Consequently, the problem that vacuum bubbles 100 are generated on an edge occurs during a cell formation process. Referring to FIG. 2a and FIG. 2b, FIG. 2a is a schematic diagram of a flat layer of a liquid crystal display panel according to an embodiment of this application, and FIG. 2b is a schematic diagram of an edge region and a display region of a liquid crystal display panel according to an embodiment of this application. The liquid crystal display panel of this application includes: a first substrate; a second substrate 10 including a display region 11 and a bezel region 12, where the bezel region 12 is located on an edge of the second substrate 10 and surrounds the display region 11; a color filter layer 20, located on the display region 11 of the second substrate 10, where the color filter layer 20 has a first thickness D1; and a flat layer 30, located on the bezel region 12 of the second substrate 10, and surrounding the color filter layer 20, where the flat layer 30 has a second thickness D2, and the second thickness D2 is the same as the first thickness D1, so that the flat layer 30 is flush with the color filter layer 20, and the flat layer 30 is connected to the color filter layer 20 to form a same plane. Further, a support column 40 is located on the color filter layer 20, and the first substrate 50 is located on the support column 40. The support column 40 is used to support the first substrate 50.

Furthermore, a black matrix 60 is further included between the first substrate 50 and the support column 40.

Further referring to FIG. 2c and FIG. 2d, FIG. 2c is a schematic diagram of a gate circuit of a liquid crystal display panel according to an embodiment of this application, and FIG. 2d is a schematic diagram of a flat layer, covering a gate circuit, of a liquid crystal display panel according to an embodiment of this application. In an embodiment of this application, a gate dielectric layer 31 of an edge region defines a through hole by using an additional photomask to perform a bridging function on a circuit signal, and therefore a flat layer 30 may directly cover the gate dielectric layer 31, and no through hole needs to be designed on the flat layer 30.

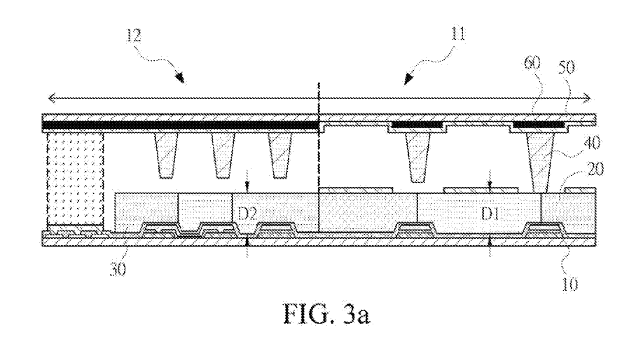

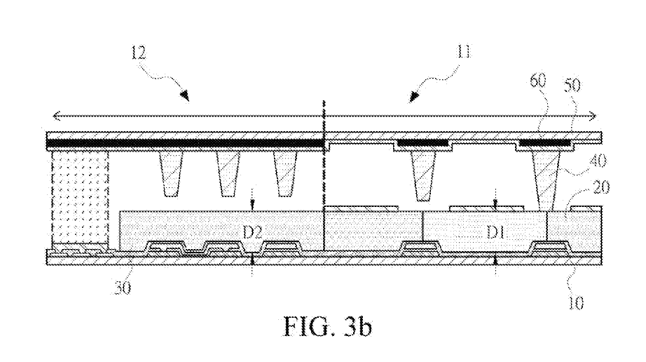

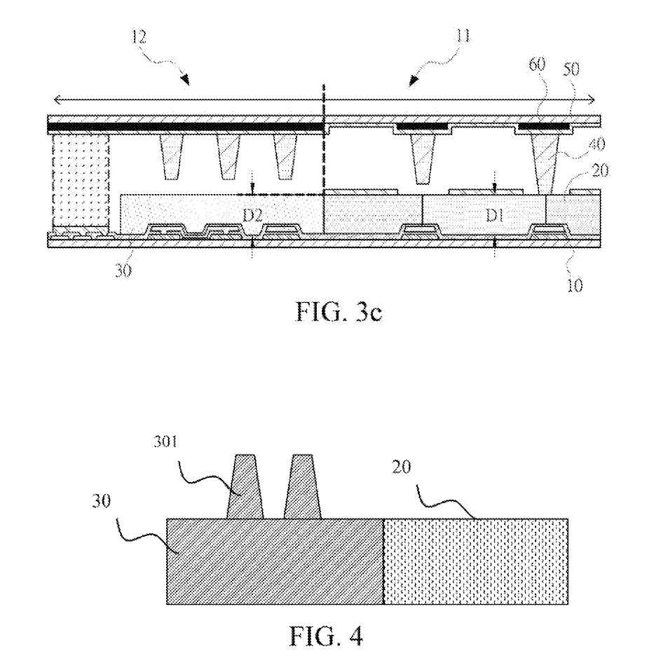

Next, referring to FIG. 3a, FIG. 3a is a schematic diagram of a flat layer, including color filter layers of three colors, of a liquid crystal display panel according to an embodiment of this application. In an embodiment of this application, the flat layer 30 includes a red color filter layer, a green color filter layer, and a blue color filter layer. That is, color filter layers of three colors simultaneously exist.

In addition, referring to FIG. 3b, FIG. 3b is a schematic diagram of a flat layer, being a single color filter layer, of a liquid crystal display panel according to an embodiment of this application. In an embodiment of this application, the flat layer 30 is a red color filter layer, a green color filter layer, or a blue color filter layer. That is, the flat layer 30 is a color filter layer of only a single color.

Further, referring to FIG. 3c, FIG. 3c is a schematic diagram of a flat layer, being a white color filter layer, of a liquid crystal display panel according to an embodiment of this application. In an embodiment of this application, the flat layer 30 is a white color filter layer.

In an embodiment of this application, the flat layer 30 is a polymer material layer.

The beneficial effects of this application are as follows: The flat layer has the second thickness, and the second thickness is the same as the first thickness. Therefore, the flat layer is flush with the color filter layer, and the flat layer is connected to the color filter layer to form a same plane. Therefore, this can resolve the problem of vacuum bubbles on an edge caused because a large mismatch between the display region and the edge region leads to poor liquid crystal dispersion during cell formation, and effectively reduce a use area of a circuit design end and improve a success rate after cell formation, so that the substrates become smaller.

Further, the beneficial effects of this application are as follows: The color filter layer and the flat layer use a same material. Therefore, costs can be effectively reduced, and a success rate after cell formation can be improved.

Further, this application further includes a liquid crystal display apparatus, including: a first substrate 50; a second substrate 10; and a liquid crystal layer, located between the first substrate 50 and the second substrate 10. Referring to FIG. 2a and FIG. 2b again, FIG. 2a is a schematic diagram of a flat layer of a liquid crystal display panel according to an embodiment of this application, and FIG. 2b is a schematic diagram of an edge region and a display region of a liquid crystal display panel according to an embodiment of this application. The second substrate includes a color filter layer 20, a flat layer 30, a display region 11, and a bezel region 12. The bezel region 12 is located on an edge of the second substrate 10 and surrounds the display region 11. The color filter layer 20 is located on the display region 11 of the second substrate 10. The color filter layer 20 has a first thickness D1. The flat layer 30 is located on the bezel region 12 of the second substrate 10, and surrounds the color filter layer 20, the flat layer 30 has a second thickness D2, and the second thickness D2 is the same as the first thickness D1, so that the flat layer 30 is flush with the color filter layer 20, and the flat layer 30 is connected to the color filter layer 20 to form a same plane. Further, a support column 40 is located on the color filter layer 20, and a first substrate 50 is located on the support column 40. The support column 40 is used to support the first substrate 50. Furthermore, a black matrix 60 is further included between the first substrate 50 and the support column 40.

Further referring to FIG. 2c and FIG. 2d, FIG. 2c is a schematic diagram of a gate circuit of a liquid crystal display panel according to an embodiment of this application, and FIG. 2d is a schematic diagram of a flat layer, covering a gate circuit, of a liquid crystal display panel according to an embodiment of this application. In an embodiment of this application, a gate dielectric layer 31 of an edge region defines a through hole by using an additional photomask to perform a bridging function on a circuit signal, and therefore a flat layer 30 may directly cover the gate dielectric layer 31, and no through hole needs to be designed on the flat layer 30.

Next, referring to FIG. 3a again, FIG. 3a is a schematic diagram of a flat layer, including color filter layers of three colors, of a liquid crystal display panel according to an embodiment of this application. In an embodiment of this application, the flat layer 30 includes a red color filter layer, a green color filter layer, and a blue color filter layer. That is, color filter layers of three colors simultaneously exist.

In addition, referring to FIG. 3b again, FIG. 3b is a schematic diagram of a flat layer, being a single color filter layer, of a liquid crystal display panel according to an embodiment of this application. In an embodiment of this application, the flat layer 30 is a red color filter layer, a green color filter layer, or a blue color filter layer. That is, the flat layer 30 is a color filter layer of only a single color.

Further, referring to FIG. 3c again, FIG. 3c is a schematic diagram of a flat layer, being a white color filter layer, of a liquid crystal display panel according to an embodiment of this application. In an embodiment of this application, the flat layer 30 is a white color filter layer.

A method for manufacturing a liquid crystal display panel of this application includes:

providing a first substrate 50;

providing a second substrate 10 including a display region 11 and bezel region 12, where the bezel region is located on an edge of the second substrate and surrounds the display region;

forming a color filter layer 20 on the display region of the second substrate 10, where the color filter layer has a first thickness;

forming a flat layer 30 on the bezel region 12 of the second substrate 20, where the flat layer surrounds the color filter layer 20, and at least some materials of the flat layer 30 are the same as at least some materials of the color filter layer 20; and

forming a liquid crystal layer (not shown) between the first substrate 50 and the second substrate 10, where

the flat layer 30 has a second thickness, and the second thickness is the same as the first thickness, so that the flat layer is flush with the color filter layer 20, and the flat layer is connected to the color filter layer to form a same plane.

Specifically, when a color filter of a specific color of the color filter layer 20 is formed, the material of the color filter of the specific color may be used to simultaneously form the flat layer 30. Therefore, at least some materials of the flat layer 30 may be the same as at least some materials of the color filter layer 20.

In this embodiment of this application, the color filter layer 20 is formed on an active switch (such as a TFT) array (not shown) of the second substrate 10.

Further, referring to FIG. 4, FIG. 4 is a schematic diagram of a flat layer and a color filter layer of a liquid crystal display panel according to an embodiment of this application. In an embodiment of this application, when the flat layer 30 is formed, a secondary support column 301 may be simultaneously formed on the flat layer. The length of the secondary support column 301 is less than the length of the support column 40. The secondary support column 301 may be integrally formed on the flat layer 30. That is, the secondary support column 301 and the flat layer 30 have a same material, and the secondary support column 301 and the flat layer 30 may be simultaneously formed in a same photomask manufacturing process.

The beneficial effects of this application are as follows: According to this application, the flat layer has the second thickness, and the second thickness is the same as the first thickness. Therefore, the flat layer is flush with the color filter layer, and the flat layer is connected to the color filter layer to form a same plane. Therefore, this can resolve the problem of vacuum bubbles on an edge caused because a large mismatch between the display region and the edge region leads to poor liquid crystal dispersion during cell formation, and effectively reduce a use area of a circuit design end and improve a success rate after cell formation, so that the substrates become smaller.

Further, the beneficial effects of this application are as follows: According to this application, the color filter layer and the flat layer use a same material. Therefore costs can be effectively reduced, and a success rate after cell formation can be improved.

The wordings such as “in some embodiments” and “in various embodiments” are repeatedly used. The wordings usually refer to different embodiments, but they may also refer to same embodiments. The words, such as “comprise”, “have”, and “include”, are synonyms, unless other meanings are indicated in the context thereof.

Descriptions above are merely preferred embodiments of this application, and are not intended to limit this application in any form. Although this application has been disclosed above in forms of preferred embodiments, the embodiments are not intended to limit this application. A person skilled in the art can make some equivalent variations, alterations, or modifications to the above disclosed technical content without departing from the scope of the technical solutions of this application to obtain equivalent embodiments. Any simple alteration, equivalent change, or modification made to the foregoing embodiments according to the technical essence of this application without departing from the content of the technical solutions of this application shall fall within the scope of the technical solutions of this application.

What is claimed is:

1. A method for manufacturing a liquid crystal display panel, comprising:
providing a first substrate;
providing a second substrate comprising a display region and a bezel region, wherein the bezel region is located on an edge of the second substrate and surrounds the display region;
forming a color filter layer on the display region of the second substrate, wherein the color filter layer has a first thickness;
forming a flat layer on the bezel region of the second substrate, wherein the flat layer surrounds the color filter layer, and at least some materials of the flat layer are the same as at least some materials of the color filter layer; and
forming a liquid crystal layer between the first substrate and the second substrate, wherein
the flat layer has a second thickness, and the second thickness is the same as the first thickness, so that the flat layer is flush with the color filter layer, and the flat layer is connected to the color filter layer to form a same plane.

2. The method for manufacturing a liquid crystal display panel according to claim 1, wherein the flat layer covers a gate dielectric layer.

3. The method for manufacturing a liquid crystal display panel according to claim 1, wherein the color filter layer is formed on an active switch array of the second substrate.

4. The method for manufacturing a liquid crystal display panel according to claim 1, wherein the flat layer comprises a red color filter layer, a green color filter layer, and a blue color filter layer.

5. The method for manufacturing a liquid crystal display panel according to claim 1, wherein the flat layer is a red color filter layer.

6. The method for manufacturing a liquid crystal display panel according to claim 1, wherein the flat layer is a green color filter layer.

7. The method for manufacturing a liquid crystal display panel according to claim 1, wherein the flat layer is a blue color filter layer.

8. The method for manufacturing a liquid crystal display panel according to claim 1, wherein the flat layer is a white color filter layer.

9. The method for manufacturing a liquid crystal display panel according to claim 1, wherein the flat layer is a polymer material layer.

10. The method for manufacturing a liquid crystal display panel according to claim 1, wherein a support column is disposed on the first substrate.

11. The method for manufacturing a liquid crystal display panel according to claim 10, wherein a black matrix is further comprised between the first substrate and the support column.

12. The method for manufacturing a liquid crystal display panel according to claim 10, wherein when the flat layer is formed, a secondary support column is formed on the flat layer.

13. The method for manufacturing a liquid crystal display panel according to claim 12, wherein a length of the secondary support column is less than a length of the support column.

14. The method for manufacturing a liquid crystal display panel according to claim 12, wherein the secondary support column is integrally formed on the flat layer.

15. The method for manufacturing a liquid crystal display panel according to claim 12, wherein the secondary support column and the flat layer are simultaneously formed in a same photomask manufacturing process.

16. A method for manufacturing a liquid crystal display panel, comprising:
providing a first substrate, wherein a support column is disposed on the first substrate;
providing a second substrate comprising a display region and a bezel region, wherein the bezel region is located on an edge of the second substrate and surrounds the display region;
forming a color filter layer on the display region of the second substrate, wherein the color filter layer has a first thickness;
forming a flat layer on the bezel region of the second substrate, wherein the flat layer surrounds the color filter layer, and at least some materials of the flat layer are the same as at least some materials of the color filter layer; and
forming a liquid crystal layer between the first substrate and the second substrate, wherein
the flat layer has a second thickness, and the second thickness is the same as the first thickness, so that the flat layer is flush with the color filter layer, and the flat layer is connected to the color filter layer to form a same plane; and
when the flat layer is formed, a secondary support column is formed on the flat layer, and a length of the secondary support column is less than a length of the support column.
